(19) United States
(12) Patent Application Publication
(10) Pub. No.: US 2009/0160869 A1
(43) Pub. Date: Jun. 25, 2009

(54) EXTENDED TEXTURE MAPPING UNIT

(76) Inventors: MIKHAIL SMELYANSKIY, San Francisco, CA (US); JATIN CHHUGANI, Santa Clara, CA (US)

Correspondence Address: CARRIE A. BOONE, P.C., 2450 Louisiana, Suite # 400-711, HOUSTON, TX, 77006, US

(21) Appl. No.: 11/963,161

(22) Filed: Dec. 21, 2007

(51) Int. Cl. G06T 11/40

(52) U.S. Cl. 345/582

(57) ABSTRACT

An extended TMU system of a graphics system is disclosed. The extended TMU system includes a novel parameter, which allows the texture mapping unit to obtain multiple samples, calculate a dot product for the multiple samples, and return a sample of a maximum dot product value, all in a single call. The extended TMU system speeds up the performance of a primitive operation essential to collision detection. Compared to other approaches, the extended TMU system reduce the amount of data transferred during the primitive computation between the core and the TMU by around 75%, and also improves the throughput between 10%-40% for three fundamental collision detection algorithms.

### TECHNICAL FIELD

This application relates to texture mapping units and, more particularly, for the use of texture mapping units for collision detection.

### BACKGROUND

The problem of deciding if a group of convex bodies are in contact with each other, known as convex collision detection, is an expensive one—particularly if the objects are discrete and highly tessellated. Conventionally, cube map functionality may operate as follows. Given an input direction (dir), the hardware computes the appropriate face of the cube that the direction points to, and the texture coordinates (u,v) on that face. The hardware then looks up the nearest texture values (up to four values, depending on the filtering mode), and returns a weighted combination of these values. For example, in case of bilinear filtering, the hardware computes the appropriate weights of the four samples, and returns the weighted sum. In other cases, simply one of the four samples is returned.

In collision detection, the support mapping of a discrete, convex body in three dimensions may be a mapping from directions to points on the surface of the body. More precisely, the support mapping of an object, O, returns the vertex on O that has the greatest dot product with the input direction. Such a vertex is called the support vertex. An example of support mapping is shown in FIG. 1 for a six-vertex polygon 50 in two dimensions. The support vertex along the vector, dir1, is vertex B, while support mapping along the dir2 direction is vertex D. Support mapping may be among the most time-consuming operations performed in collision detection algorithms.

FIG. 1 depicts an example where the run-time system requires the support map 70 for a direction that is not one of the pre-sampled ones. In this figure, a convex object 72 is embedded inside a cube map 74, with a direction vector (dir) emanating from the center of the object, and crossing the right face of the cube. FIG. 1 also shows a close-up of a small square area 76 on the face of the cube map 70, which intersects with the direction vector, dir. The close-up consists of 4×4 samples 78. The direction vector, dir, does not intersect with any of the samples 78, but rather crosses some point (denoted by a square-filled dot 82) between four samples 78A, 78B, 78C, and 78D. These directions, which are not pre-sampled, are the most frequently occurring cases, compared to pre-sampled directions. For such cases, the texture unit returns the four nearest samples, 78A, 78B, 78C, and 78D, from the cube map using four different calls to the texture unit. The CPU then computes a maximum value and returns the sample that maximizes the dot product with the input direction.

Thus, there is a need to perform texture mapping that overcomes the shortcomings of the prior art.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is an illustration where a run-time system requires the support map for a direction that is not one of the pre-sampled ones, according to the prior art;

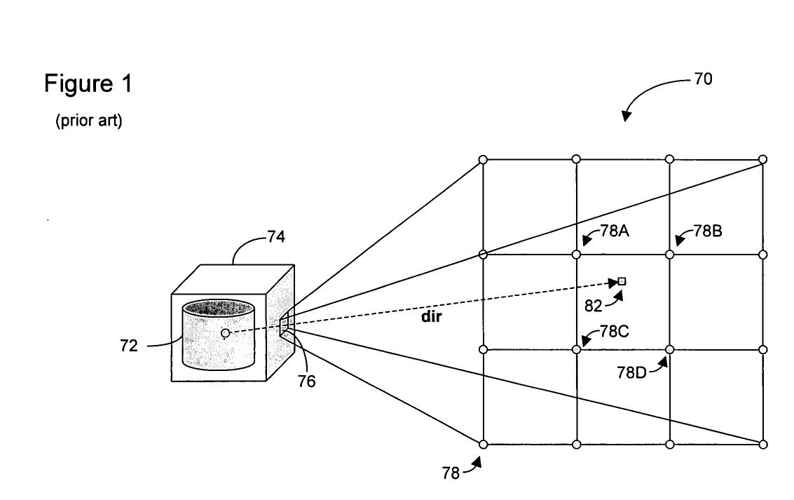

FIG. 2 is a block diagram of an extended texture mapping system, according to some embodiments;

FIG. 3 is a flow diagram illustrating operations performed by the extended TMU system of FIG. 2, according to some embodiments.

### DETAILED DESCRIPTION

In accordance with the embodiments described herein, an extended texture mapping unit (TMU) system of a graphics system is disclosed. The extended TMU system includes a novel parameter, which allows the texture mapping unit to obtain multiple samples, calculate a dot product for the multiple samples, and return a sample of a maximum dot product value, all in a single call. The extended TMU system speeds up the performance of a primitive operation essential to collision detection.

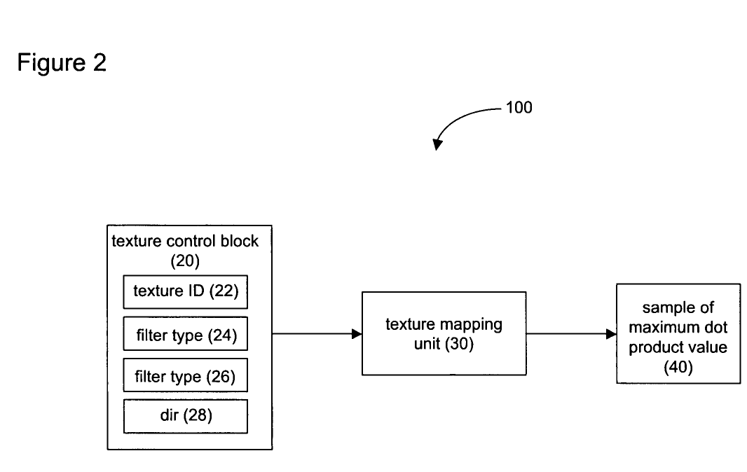

FIG. 2 is a block diagram of an extended TMU system 100, according to some embodiments. The extended TMU system 100 includes a texture control block (TCB) 20 to be received into a texture mapping unit (TMU) 30, and generates a vertex index of a maximum dot product value 40. The system 100 enables multiple samples to be obtained, the dot product to be performed, and the vertex index corresponding to the maximum dot product to be returned, in a single call to the TMU 30. This saves communication bandwidth between the caller and the TMU system, as well as offloading computations from the caller.

The texture control block 20 includes parameters that indicate operations to be performed by the TMU 30. Not all possible parameters are shown in FIG. 2, for simplicity. The TCB 20 includes a texture identifier (ID) parameter 22, a filter type parameter 24, a second filter type parameter 26, and a direction parameter, dir 28. The texture ID parameter 22 specifies one of many possible textures to be used by the TMU 30. The filter type parameter 24 specifies a type of filtering operation to be performed by the TMU 30. Examples include linear filtering, bilinear filtering, anisotropic filtering, volumetric filtering, and so on.

The third parameter of the TCB 20, the second filter select parameter 26, specifies sampling criteria to the TMU 30. Table 1 shows the prior art and novel (TMU system 100) meanings for the filter select parameter 26.

TABLE 1
Prior art TMU operations based on the filter
select parameter.

| value | TMU operation | implementation |
|---|---|---|
| 0 | TMU retrieves lower left corner sample | legacy |
| 1 | TMU retrieves lower right corner sample | legacy |
| 2 | TMU retrieves upper left corner sample | legacy |
| 3 | TMU retrieves upper right corner sample | legacy |
| 5 | TMU retrieves multiple samples, calculates | TMU system 100 |
| | dot product for each, and returns vertex of | |
| | maximum dot product value | |

As shown in Table 1, when the filter select parameter 26 is a 0, the TMU retrieves a lower left corner sample from the support map. Thus, two operations take place to retrieve a single sample. First, the TCB is initialized, requesting the lower left corner (SetupTCB(c, dir, 0). Then, the TMU is executed to retrieve the lower left corner (Corner[0]=get_idx(c, dir, 0)). Similarly, when the filter select parameter 26 is a 1, two operations take place, one to specify the request in the TCB, the other to retrieve the lower right corner. When the filter select parameter 26 is a 2, the upper left corner sample is retrieved using two operations. When the filter select parameter 26 is a 3, the upper right corner sample is obtained using two operations.

However, when the filter select parameter 26 is a 5, the TMU system 100 retrieves multiple samples, calculates a dot product for each sample, and returns a vertex index of the maximum dot product value, all in a single call to the TMU 30. Thus, by specifying the filter select parameter 26 in the TCB 20 in this way, the TMU 30 is able to perform a single retrieval of the sample, which corresponds to the maximum dot product with the direction vector. In some embodiments, the number of samples retrieved is four. In other embodiments, the number of samples retrieved is more than four.

In some embodiments, the filter select parameter 26 may specify to the TMU 30 that multiple samples are to be obtained and returned, but dot product and maximum calculations are not made by the TMU. This is what happens when the filter select parameter 26 is a 6. System designers of ordinary skill in the art recognize the filter select parameter 26 may be further defined, depending on the desired results to be obtained from the TMU.

Pseudo-code for the prior art lookup method is as follows, where TCB is a texture control block:

```
Vertex = compute_support_mapping(dir[3], cube_map c)
{
  SetupTCB(c, dir, 0); // Sets up the TCB to return the lower-left corner
  Corner[0] = get_idx(c, dir, 0); //texture lookup on the current
  architecture
  SetupTCB(c, dir, 1); // Sets up the TCB to return the lower-right corner
  Corner[1] = get_idx(c, dir, 1); //texture lookup on the current
  architecture
  SetupTCB(c, dir, 2); // Sets up the TCB to return the top-left corner
  Corner[2] = get_idx(c, dir, 2); //texture lookup on the current
  architecture
  SetupTCB(c, dir, 3); // Sets up the TCB to return the top-right corner
  Corner[3] = get_idx(c, dir, 3); //texture lookup on the current
  architecture
// out of 4 corners, find the one that maximizes dot product with dir and
// return it as support vertex.
  max_dot = −∞;
  max_index = −1;
  for(i=0; i < 4; i++) {
    current_dot = DotProduct(Corner[i], dir);
    if(current_dot > max_dot) {
      max_dot = current_dot;
      max_index = i;
    }
  }
  Return Corner[max_index];
}
```

The above prior art approach has the several inefficiencies due to software overhead. First, the CPU must execute some initialization code to set up before making a call to the texture unit for each of the four lookups. The initialization may include setting up a texture control block (TCB). The texture control block is one example of a software mechanism to communicate between the core and texture sampler, wherein the programmer fills in the control block information with the data fields, which instruct the texture sampler on what actions to take. For example, among other things, the TCB provides to the texture sampler information about which filtering algorithm, as well as which texture format, to use. Second, each of the lookups requires a separate texture fetch from the texture mapping unit, thus increasing on-die traffic. Third, once all four texture values (vertices) are brought into the CPU, the CPU must find the vertex that maximizes the dot product with the given direction.

The sequence of steps enumerated above results in substantial software overhead incurred by the Chhugani art software implementation.

The pseudo-code for performing the extended TMU 100, where the filter select parameter 26 is a 5, is as follows:

```
Vertex = compute_support(dir[3], cube map c)
{
// Sets up the TCB to return the maximum dot product value
SetupTCB(c, dir, 5);
// calls TMU to perform 4 texture lookups and return the vertex that
// maximizes the dot product
  Corner = get_max_idx(c, dir);
Return Corner;
    }
```

The call to get_max_idx(c, dir) executes on the extended TMU. The extended TMU looks up the four nearest sample values, computes the four dot-products with the four samples, and returns the sample that maximizes the four dot products, wherein the sample is the vertex (x, y, z).

The pseudo-code for get_max_idx, executed on the extended TMU is as follows:

```
Vertex get_max_idx(c, dir)
{
  max_dot = −∞;
  max_index = −1;
  for(i=0; i<4; i++)
  {
    Corner[i] = get_idx(c, dir, i);
    current_dot = dot_product(Corner[i], dir);
    if (current_dot > max_dot)
    {
      max_dot = current_dot;
      max_index = i;
    }
  }
  Return Corner[max_index];
}
```

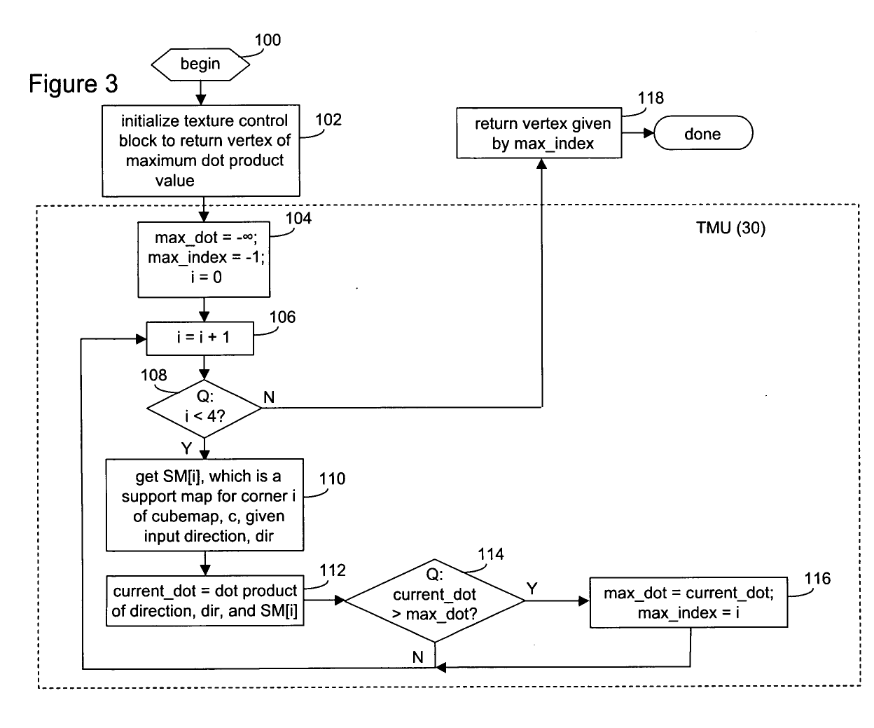

A flow diagram of FIG. 3 shows a method of operating the extended TMU system 100 of FIG. 2, according to some embodiments. The extended TMU system 100 includes operations performed within the TMU 30 (as indicated by the dotted lines) to return the desired vertex of the maximum dot product value 40. Before the TMU is called, the texture control block 10 is initialized with the texture ID parameter 22, the filter type parameter 24, the filter select parameter 26, and the direction parameter 28, among others (block 102). The filter select parameter 26 may have any value specified in Table 1. In FIG. 3, the filter select parameter 26 is set to a 5.

Once the TCB 20 is initialized and sent to the TMU 30, the variables, max_dot, max_index, and a variable, i, are initialized in the TMU (block 104). The variable, i, is incremented (block 106) for keeping track of which of four corners of the cube map, c, is being analyzed. For each corner, i, (block 108), a pre-sampled support map value, SM[i], is obtained for cube map, c, in direction, dir (block 110). A variable, current_dot, is initialized with the dot product for the current corner, i, being analyzed (block 112). When the current_dot variable exceeds the max_dot variable (block 114), the max_dot variable is replaced with the current_dot value and the max_index variable is updated (block 116). The next corner is analyzed until all four corners have been retrieved, with the corner having the maximum dot product being returned as the result (block 118).

Modern TMU hardware already supports looking up the four nearest samples (Corner[0], Corner[1], Corner[2] and Corner[3]), to perform various filtering computations, such as bilinear, anisotropic, etc. In addition, in order to perform these filtering computations, modern TMUs has a variety of hardware resources, such as add and multiply units, accumulator registers, etc. In some embodiments, the support vertex computation (bold-faced part of the above pseudo-code description) may be achieved using extensions to the existing TMU hardware, for computing the dot product and finding the vertex index of the maximum value.

The extended TMU system 100 can be used to improve the performance of any collision detection algorithm that relies on support mapping to retrieve geometric information about the convex bodies they operate on. As it turns out, many popular collision detection algorithms rely on support mapping.

Broad phase collision: The broad phase of collision detection is often solved by a method known as “sweep-and-prune”. This method examines the rough spatial relationships of the bodies in the scene and quickly eliminates certain pairs from consideration for the narrow phase. Essentially, an axis-aligned bounding box (AABB) for each object is computed. This represents the furthest extents of the object along each axis. The intervals covered by each object along each axis are considered and only those pairs of objects that overlap in all three projections are passed on to the narrow phase.

In some embodiments, the extended TMU system 100 accelerates the computation of AABB. Where current methods rely on O(n) or O(log n) computations, the extended TMU system 100 is able to find the extents of an object in a given direction in constant time. The support mapping for that direction is computed and the point returned simply projected onto the desired axis.

Narrow phase: A separating axis test (SAT) convex collision detection algorithm seeks to find a direction (and the associated plane) that separates the pair of input objects. This is done by projecting the extents of each object along that direction and comparing them. This is repeated for a number of directions until a separating axis has been found or a suitable number of tests indicate collision.

In some embodiments, the extended TMU system 100 improves the speed of SAT convex collision detection algorithms in much the same way as it can for sweep-and-prune. The extent of an object in any direction can be returned in constant time. In some embodiments, this is done for each direction and its opposite, with the points projected onto the direction vector.

Narrow phase: The GJK algorithm uses support mapping directly to collect information about the relative positions of the objects. The method itself is fairly complicated. The best-known methods for GJK spend around 50-70% of their time computing support mappings. In some embodiments, the extended TMU system 100 reduces the cost of the GJK algorithm from O(n) to O(1) as with the other applications.

In some embodiments, the performance advantage of the extended TMU system 100 is demonstrated in the context of the GJK algorithm. GJK is a popular algorithm for narrow-phase collision detection between rigid convex objects. GJK relies on support mapping to compute its result. In Table 2, the performance of GJK using the extended TMU system 100 is demonstrated on a 32 c, 2.3 GHz multiprocessor (using a cycle-accurate simulation infrastructure) with varying number of vertices in the object.

TABLE 2
Test results using extended TMU system 100.

| | # object vertices (v) | | | | | | | |
|---|---|---|---|---|---|---|---|---|
| | 8 | 16 | 32 | 64 | 128 | 256 | 512 | 1024 |
| prior art TMU | 140.5 | 107.9 | 95.4 | 86.2 | 72.3 | 66.4 | 62.15 | 57.9 |
| extended TMU | 155.3 | 118.9 | 108.3 | 97.1 | 80.3 | 74.1 | 69.8 | 65.2 |
| throughput | 10.5 | 10.2 | 13.4 | 12.7 | 11.0 | 11.5 | 12.3 | 12.6 |
| increase (%) | | | | | | | | |

In the second row, the prior art TMU, the number of collisions is reported (in millions) per second using the current architecture design of the TMU. In the third row, extended TMU, the potential number of collisions per second is reported using the extended TMU system 100. In the fourth row, the throughput improvement is shown with varying number of vertices (1^{st} row). As evident from Table 2, the extended TMU system 100 increases the throughput by around 10-13% in all cases. In addition, the extended TMU system 100 reduces the amount of data transferred between the CPU and the TMU by 75% as compared to the Chhugani art, which requires the CPU to fetch all four nearest samples from the TMU.

In some embodiments, a computation of the extended TMU system 100 shows that, for the other two collision detection algorithms, AABB and SAT, data transferred between the CPU and the TMU is reduced by 75%, while throughput is increased by around 40%, with a varying number of vertices in the object.

The extended TMU system 100 is different from prior art implementations in several aspects. First, the extended TMU system 100 stores the support vertex and not the centroid distance. Second, the extended TMU system 100 includes specific hardware acceleration to accelerate the filtering of four nearest neighbors to compute a single supporting vertex. The extended TMU system 100 is thus the first system that proposes a hardware extension to the TMU to accelerate collision detection.

The extended TMU system 100 is advantageous over prior art solutions in that it offloads computation of the support vertex to the TMU. While previous approaches had to communicate four nearest samples from the TMU to the CPU for each supporting vertex, the extended TMU system 100 reduces the amount of communication by 75% by only sending one out of four vertices from the TMU to the CPU.

Collision detection is the most important and time consuming part of any physics software development kit. In some embodiments, the extended TMU system 100 significantly accelerates collision detection on processor-based systems. While graphics hardware vendors can implement the extended TMU system 100 in software, the preferred embodiment of the extended TMU system 100 is hardware-specific.

While texture mapping unit hardware and cube map functionality is not new and many graphics vendors have it, the extended TMU system 100 is a novel hardware modification to existing TMU hardware, to accelerate the class of collision detection algorithms. The extended TMU system 100 is useful in the context of game physics, in some embodiments.

Compared to other approaches, the extended TMU system 100 may reduce the amount of data transferred during the primitive computation between the core and the TMU by around 75%, and also improve the throughput between 10%-40% for three fundamental collision detection algorithms. The extended TMU system 100 accelerates the AABB, SAT, and GJK algorithms, in some embodiments.

While the application has been described with respect to a limited number of embodiments, those skilled in the art will appreciate numerous modifications and variations therefrom. It is intended that the appended claims cover all such modifications and variations as fall within the true spirit and scope of the invention.

We claim:

1. A system, comprising:
a texture mapping unit to receive a texture control block and perform operations based on the texture control block; and
a texture control block comprising a filter select parameter, the filter select parameter to specify sampling criteria to the texture mapping unit;
wherein the sampling criteria causes the texture mapping unit to select multiple samples of a support map, calculate dot products for each sample, and return a sample corresponding to a maximum dot product value.

2. The system of claim 1, wherein the multiple samples comprise an upper left corner, an upper right corner, a lower left corner, and a lower right corner of the support map.

3. The system of claim 1, wherein the multiple samples comprise four samples of the support map.

4. The system of claim 1, wherein the multiple samples correspond to four support vertices in corners of a 2×2 quad of pre-computed support vertex samples.

5. The system of claim 1, wherein the multiple samples comprise sixteen samples of the support map.

6. The system of claim 1, the operations performed by the texture control block further comprising:
computing a first dot product of a first texture sample, the first texture sample comprising a first corner of the support map;
computing a second dot product of a second texture sample, the second texture sample comprising a second corner of the support map;
computing a third dot product of a third texture sample, the third texture sample comprising a third corner of the support map; and
computing a fourth dot product of a fourth texture sample, the fourth texture sample comprising a fourth corner of the support map;
wherein the vertex index of a maximum dot product value corresponds to one of the texture samples.

7. The system of claim 1, the texture control block further comprising:
a texture identifier; and
a filter type.

8. A method, comprising:
initializing a texture control block for a cube map and a direction, the texture control block comprising a filter select parameter; and
executing a texture mapping unit based on the texture control block, the texture mapping unit to retrieve multiple texture samples of the cube map;
wherein the texture mapping unit is executed only once.

9. The method of claim 8, executing a texture mapping unit further comprising:
calculating dot products for each texture sample;
wherein the texture map outputs a vertex of a maximum dot product value based on the calculated dot products.

10. The method of claim 8, executing a texture mapping unit based on the texture control block further comprising:
obtaining a first texture sample comprising a first corner of the cube map in the direction;
obtaining a second texture sample comprising a second corner of the cube map in the direction;
obtaining a third texture sample comprising a third corner of the cube map in the direction; and
obtaining a fourth texture sample comprising a fourth corner of the cube map in the direction.

11. The method of claim 10, wherein the first texture sample, second texture sample, third texture sample, and fourth texture sample correspond to four support vertices in corners of a 2×2 quad of pre-computed support vertex samples.

12. The method of claim 8, the texture mapping unit to retrieve multiple texture samples further comprising:
obtaining four texture samples.

13. The method of claim 8, the texture mapping unit to retrieve multiple texture samples further comprising:
obtaining sixteen texture samples.

14. The method of claim 9, further comprising:
computing a support vertex based on the multiple texture samples.
